(19) United States
(12) Patent Application Publication
(10) Pub. No.: US 2015/0303018 A1
(43) Pub. Date: Oct. 22, 2015

(54) FUSE

(71) Applicant: Murata Manufacturing Co., Ltd., Nagaokakyo-shi (JP)

(72) Inventor: Shinichiro BANBA, Nagaokakyo-shi (JP)

(21) Appl. No.: 14/753,124

(22) Filed: Jun. 29, 2015

Related U.S. Application Data
(63) Continuation of application No. PCT/JP2013/075862, filed on Sep. 25, 2013.

(30) Foreign Application Priority Data
Jan. 11, 2013 (JP) 2013-003131

(51) Int. Cl. H01H 85/00; H01H 85/48

(52) U.S. Cl. CPC H01H 85/0056; H01H 85/48; H01H 85/0065; H01H 85/006

(57) ABSTRACT

A fuse includes an insulating substrate, a wiring, low-melting-point metal portions insulating layers and metal films. The wiring is located on one principal surface of the insulating substrate. The low-melting-point metal portions are provided over the wiring. The low-melting-point metal portions have a lower melting point than the wiring, and dissolves the wiring when the portions turn into a melt. The insulating layers are located between the wiring and the low-melting-point metal portions. The metal films are located outside the insulating layers on the insulating substrate.

### BACKGROUND OF THE INVENTION

1. Field of the Invention

The present invention relates to a fuse.

2. Description of the Related Art

Conventionally, attempts have been made to connect fuses to electronic components to protect the electronic components from overcurrents. For example, Japanese Patent Application Laid-Open No. 2012-18777 discloses, as an example of a fuse, a fuse including first and second electrode parts placed on an insulating substrate, a metal wiring part that connects the first electrode part and the second electrode part, and a low-melting-point metal part placed on a portion of the metal wiring part.

However, because the fuse disclosed in Japanese Patent Application Laid-Open No. 2012-18777 is provided with the low-melting-point metal part which has conductivity on the metal wiring part, the metal wiring part is low in resistivity, and less likely to generate heat when an overcurrent flows. For this reason, the fuse disclosed in Japanese Patent Application Laid-Open No. 2012-18777 has a problem of being less likely to cause disconnection, that is, a problem of possibly failing to ensure that overcurrent is interrupted.

### SUMMARY OF THE INVENTION

Preferred embodiments of the present invention provide a fuse capable of ensuring that overcurrent is interrupted.

A fuse according to a preferred embodiment of the present invention includes an insulating substrate, a wiring, a low-melting-point metal portion, an insulating layer, and metal films. The wiring is located on one principal surface of the insulating substrate. The low-melting-point metal portion is provided over the wiring. The low-melting-point metal portion has a lower melting point than the wiring, and dissolves the wiring when the metal portion turns into a melt. The insulating layer is located between the wiring and the low-melting-point metal portion. The metal films are located outside the insulating layer on the insulating substrate.

In another certain aspect of the fuse according to a preferred embodiment of the present invention, the low-melting-point metal portion is provided in contact with the metal films.

In other certain aspect of the fuse according to a preferred embodiment of the present invention, the metal films are provided on both sides of the insulating layer in the width direction of the wiring.

In yet other certain aspect of the fuse according to a preferred embodiment of the present invention, the low-melting-point metal portion covers an area extending from one of the two metal films to the other.

In yet another certain aspect of the fuse according to a preferred embodiment of the present invention, the fuse connects the low-melting-point metal portion to the metal film, and further includes a high-melting-point metal portion that is higher in melting point than the low-melting-point metal portion, and lower in melting point than the metal films.

In yet other certain aspect of the fuse according to a preferred embodiment of the present invention, the melting point of the insulating layer is higher than the melting point of the low-melting-point metal portion.

In yet another certain aspect of the fuse according to a preferred embodiment of the present invention, the insulating layer is composed of a thermoplastic resin.

In yet other certain aspect of the fuse according to a preferred embodiment of the present invention, the fuse further includes a heating element that heats the low-melting-point metal portion.

In yet another certain aspect of the fuse according to a preferred embodiment of the present invention, the low-melting-point metal portion contains Sn as its main constituent.

According to preferred embodiments of the present invention, a fuse which is capable of ensuring that overcurrent is interrupted is provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic plan view of a fuse according to a preferred embodiment of the present invention.

FIG. 2 is a schematic back view of a fuse according to a preferred embodiment of the present invention.

FIG. 3 is a schematic cross-sectional view of FIG. 1 along the line III-III.

FIG. 4 is a schematic cross-sectional view of FIG. 1 along the line IV-IV.

FIG. 5 is a schematic cross-sectional view of FIG. 1 along the line V-V.

FIG. 6 is a schematic plane view for illustrating the shape of a second electrode layer according to a preferred embodiment of the present invention.

FIG. 7 is a schematic plane view for illustrating the shapes of a first electrode layer and a heating element according to a preferred embodiment of the present invention.

FIG. 8 is a schematic circuit diagram of a fuse according to a preferred embodiment of the present invention.

FIG. 9 is a schematic cross-sectional view of a fuse according to a first modification example of a preferred embodiment of the present invention.

FIG. 10 is a schematic cross-sectional view of a fuse according to a second modification example of a preferred embodiment of the present invention.

FIG. 11 is a schematic cross-sectional view of a fuse according to a third modification example of a preferred embodiment of the present invention.

### DETAILED DESCRIPTION OF THE PREFERRED EMBODIMENTS

Examples of preferred embodiments of the present invention will be described below. However, the following preferred embodiments is provided by way of example only. The present invention is not limited to the following preferred embodiments in any way.

Furthermore, members that have the same or substantially the same functions shall be denoted by the same reference symbols in the respective drawings referenced in the preferred embodiments, etc. In addition, the drawings referenced in the preferred embodiments, etc. are schematically made. The ratios between the dimensions, etc. of the elements shown in the drawings may differ from the ratios between the dimensions, etc. of real elements. The dimensional ratios, etc. of the objects may also differ between the drawings. The dimensional ratios, etc. of specific elements should be determined in view of the following description.

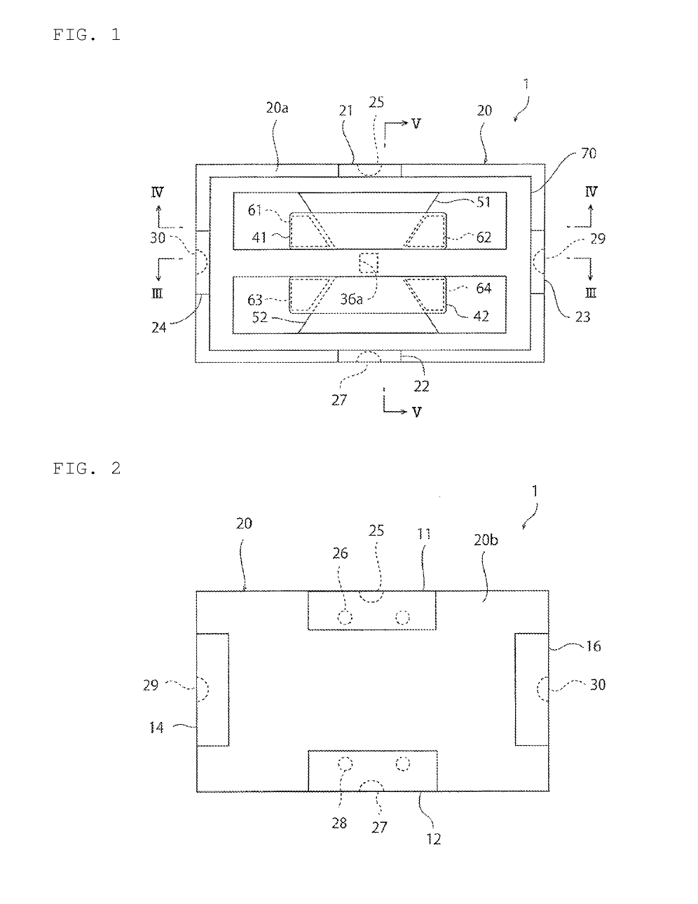

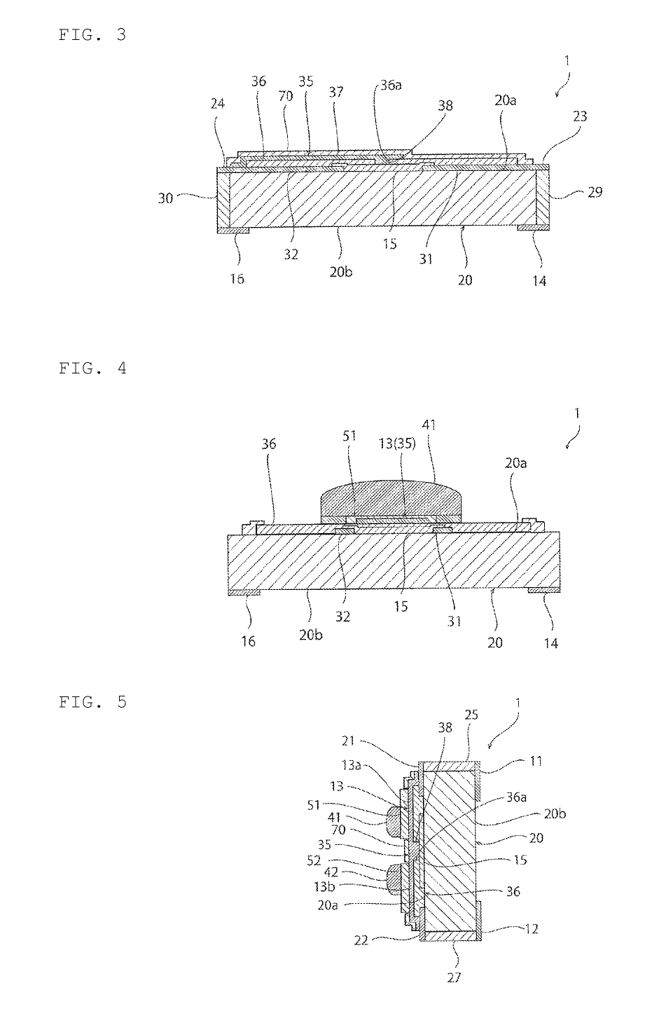

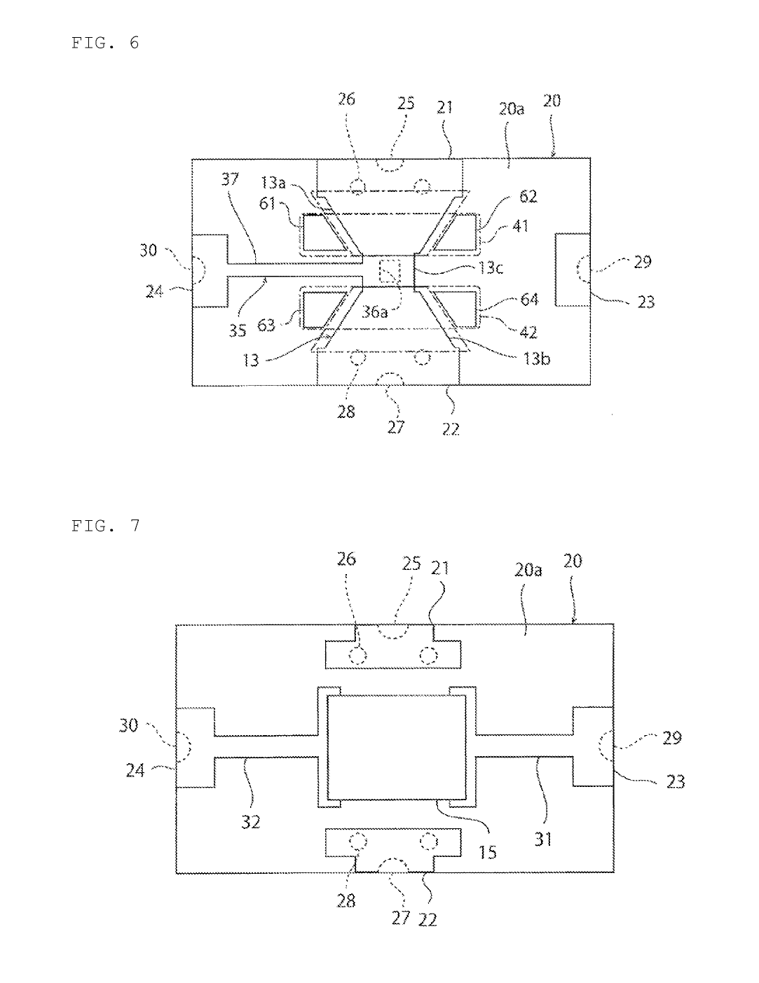

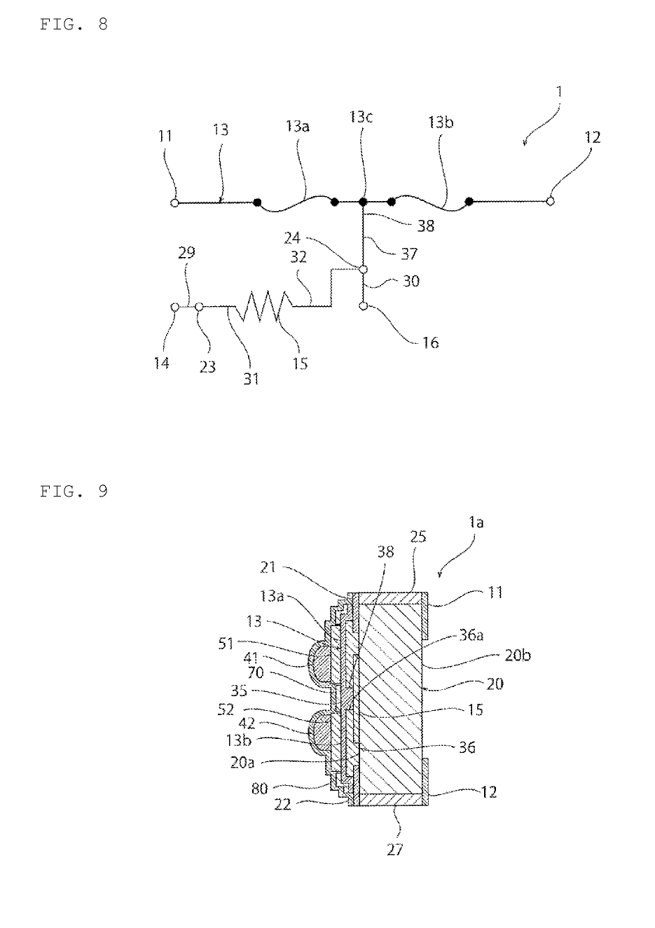

FIG. 1 is a schematic plan view of a fuse according to the present preferred embodiment. FIG. 2 is a schematic back view of the fuse according to the present preferred embodiment. FIG. 3 is a schematic cross-sectional view of FIG. 1 along the line III-III. FIG. 4 is a schematic cross-sectional view of FIG. 1 along the line IV-IV. FIG. 5 is a schematic cross-sectional view of FIG. 1 along the line V-V. FIG. 6 is a schematic plane view for illustrating the shape of a second electrode layer according to the present preferred embodiment. FIG. 7 is a schematic plane view for illustrating the shapes of a first electrode layer and a heating element according to the present preferred embodiment. FIG. 8 is a schematic circuit diagram of the fuse according to the present preferred embodiment. It is to be noted that the drawing of members located on the members to be described is omitted in FIGS. 6 and 7.

As shown in FIG. 8, a fuse 1 preferably includes a wiring 13 connected between a first terminal 11 and a second terminal 12. The wiring 13 includes fuse electrode portions 13a and 13b connected in series. The fuse electrode portions 13a, 13b herein refer to portions that are fused to achieve insulation between the first terminal 11 and the second terminal 12, when an overcurrent flows through the fuse 1 or when a signal to achieve the fuse function is input to the fuse 1. For example, when an overcurrent flows between the first terminal 11 and the second terminal 12, at least one of the fuse electrode portions 13a, 13b is fused. Thus, the first terminal 11 and the second terminal 12 are insulated from each other. For this reason, the fuse 1 defines and functions as a passive element that detects an overcurrent, and has the wiring 13 automatically broken. It is to be noted that the wiring 13 preferably has a thickness, for example, on the order of about 5 μm to about 20 μm.

The connecting point 13c between the fuse electrode portion 13a and the fuse electrode portion 13b is connected to a fourth terminal 16. A heating element 15 includes a resistor is provided between a third terminal 14 and the connecting point 13c. When power is supplied between the third terminal 14 and at least one of the first and second terminals 11, 12, the heating element generates heat. Then, at least one of the fuse electrode portion 13a and fuse electrode portion 13b is fused to insulate the first terminal 11 and the second terminal 12 from each other. For this reason, the fuse 1 also defines and functions as an active element that detects an overcurrent to actively break the wiring 13. It is to be noted that the fuse according to preferred embodiments of the present invention may function only as a passive element, or function only as an active element.

Next, the specific structure of the fuse 1 will be described in detail with reference to FIGS. 1 through 7.

As shown in FIGS. 1 through 5, the fuse 1 includes an insulating substrate 20. The insulating substrate 20 may include, for example, a ceramic substrate such as an alumina substrate, a resin substrate, or the like. The insulating substrate 20 may be a multilayer substrate with wirings therein.

The insulating substrate 20 includes a first principal surface 20a and a second principal surface 20b. As shown in FIG. 2, the first to fourth terminals 11, 12, 14, 16 are located on the second principal surface 20b. The fourth terminal 16 is connected to the connecting point between the heating element 15 and the connecting point 13c as shown in FIG. 8. It is to be noted that the first to fourth terminals 11, 12, 14, 16 may be made of an appropriate conductive material such as Ag, AgPt, AgPd, or Cu. The first to fourth terminals 11, 12, 14, 16 preferably have a thickness, for example, on the order of about 10 μm to about 20 μm.

As shown in FIGS. 1 and 6, electrodes 21 to 24 are provided over the first principal surface 20a. The electrode 21 is connected to the first terminal 11 with a side surface electrode 25 and a via hole electrode 26 (see FIG. 2). The electrode 22 is connected to the second terminal 12 with a side surface electrode 27 and a via hole electrode 28. The electrode is connected to the third terminal 14 with a side surface electrode 29. The electrode 24 is connected to the fourth terminal 16 with a side surface electrode 30. It is to be noted that the electrodes 21 to 24 each preferably include an appropriate conductive material such as Ag, AgPt, AgPd, or Cu.

As shown in FIG. 7, the heating element 15 connected between the electrode 23 and the electrode 24 is provided over the principal surface 20a. The electrode 23 and the heating element 15 are connected with a wiring 31. The electrode 24 and the heating element 15 are connected with a wiring 32. The heating element 15 is supported by the insulating substrate 20. It is to be noted that the heating element 15 preferably includes, for example, a resistance heating element of RuO₂, AgPd, or the like.

An electrode layer 35 (see FIGS. 3 through 6) is provided over the electrodes 23, 24, the heating element 15 and the wirings 31, 32. An insulating layer 36 is located between the electrode layer 35, and the electrodes 23, 24 and the wirings 31, 32. In the present preferred embodiment, the insulating layer 36 is provided over the entire overlap between the wirings 31, 32 and the low-melting-point metal portions 41, 42. However, in preferred embodiments of the present invention, for example, the insulating layer may have an opening or the like configured to connect the wirings and the low-melting-point metal portions to the extent that the electrical resistance of the wirings is not excessively decreased as a whole. As shown in FIGS. 3 and 5, the insulating layer 36 is provided with a through hole 36a. This through hole 36a is connected to each of the heating element 15 and wiring 13 (more specifically, connecting point 13c). The through hole 36a may preferably have a constant or substantially constant diameter or have a tapered shape in a direction in which the central axis extends. The through hole 36a may be provided, for example, in a tapered shape that is tapering toward the insulating substrate 20. It is to be noted that the insulating layer 36 preferably has a thickness, for example, on the order of about 15 μm to about 30 μm.

As shown in FIGS. 5 and 6, the electrode layer 35 includes the wiring 13 connecting the electrode 21 and the electrode 22. The wiring 13 includes the fuse electrode portion 13a and the fuse electrode portion 13b. The connecting point 13c between the fuse electrode portion 13a and the fuse electrode portion 13b is connected to the electrode 24 by an electrode 37 as shown in FIGS. 3 and 6. In addition, the connecting point 13c is connected to the heating element 15 through a high heat conductor 38 located in the through hole 36a. The thermal conductivity of the high heat conductor 38 is higher than the thermal conductivity of the insulating layer 36. The high heat conductor 38 may preferably be made of, for example, metal. In the present preferred embodiment, the high heat conductor 38 and the wiring 13 are integrally provided. In this case, the high hear conductor 38 is easily provided.

It is to be noted that the electrode layer 35 preferably has a thickness, for example, on the order of about 5 μm to about 20 μm.

As shown in FIGS. 1, 4, and 5, low-melting-point metal portions 41, 42 are provided on the respective fuse electrode portions 13a, 13b of the wiring 13. The low-melting-point metal portions 41, 42 have a lower melting point than the wiring 13, and is preferably made of low-melting-point metal that melts the wiring 13 when the portions turn into a melt. The low-melting-point metal may, for example, contain Sn as its main constituent. Specific examples of this low-melting-point metal include Sn alloys such as, for example, SnSb, SnCu, SnAg, SnAgCu, and SnCuNi. The low-melting-point metal portions 41, 42 may preferably have a thickness, for example, on the order of about 0.1 mm to about 0.5 mm.

Further, a protective film such as a flux layer, an antioxidant film, or the like may be provided on the low-melting-point metal portions 41, 42, so as to at least partially cover the low-melting-point metal portions 41, 42.

As shown in FIGS. 4 and 5, the fuse 1 includes insulating layers 51, 52 located between the wiring 13 and the low-melting-point metal portions 41, 42. The melting point of the insulating layers 51, 52 is higher than the melting point of the low-melting-point metal portions 41, 42. The insulating layers 51, 52 preferably have a melting point of about 180° C. to about 350° C., and more preferably about 220° C. to about 320° C. The insulating layers 51, 52 may preferably be made of, an appropriate insulating material, but preferably made of, for example, a thermoplastic resin. Thermoplastic resins that are preferably used to configure the insulating layers 51, 52 include, for example, polyester resins such as polyethylene terephthalate (PET, melting point: 264° C.) and polybutylene terephthalate (PBT, melting point: 232° C.); vinyl resins such as polyvinyl chloride (melting point: 180° C.); polystyrene resins such as polystyrene (melting point: 230° C.); polyamide resins such as nylon 6 (registered trademark, melting point: 225° C.) and nylon 66 (registered trademark, melting point 267° C.); polycarbonate resins such as polycarbonate (melting point: 250° C.); and fluorine resins such as polyvinylidene fluoride (melting point: 210° C.) and chlorotrifluoroethylene (melting point: 220° C.). The insulating layers 51, 52 may preferably have a thickness, for example, on the order of about 10 μm to about 200 μm, and more preferably about 20 μm to about 150 μm.

As show in FIG. 6, on the insulating substrate 20, metal films 61 to 64 are located outside the insulating layers 51, 52. The metal films 61 to 64 are preferably made of, for example, metal or an alloy that has high wettability to a melt of the low-melting-point metal portions 41, 42, such as Ag, AgPt, AgPd, and Cu. Moreover, the metal films 61 to 64 are preferably less likely to be dissolved in a melt of the low-melting-point metal portions 41, 42, and preferably made of, in particular, AgPt, AgPd, or the like.

The metal films 61 to 64 are provided on both sides of the insulating layers 51, 52 in the width direction of the wiring 13. In the present preferred embodiment, specifically, the metal films 61, 62 are provided on both sides of the insulating layer 51 in the width direction of the wiring 13. The metal films 61, 62 sandwich the fuse electrode portion 13a in the width direction of the wiring 13. The low-melting-point metal portion 41 is provided to be brought into contact with the metal films 61, 62. Specifically, the low-melting-point metal portion 41 is provided over the metal film 61, the insulating layer 51, and the metal film 62.

The metal films 63, 64 are provided on both sides of the insulating layer 52 in the width direction of the wiring 13. The metal films 63, 64 sandwich the fuse electrode portion 13b in the width direction of the wiring 13. The low-melting-point metal portion 42 is provided to be brought into contact with the metal films 63, 64. Specifically, the low-melting-point metal portion 42 is provided over the metal film 63, the insulating layer 52, and the metal film 64.

It is to be noted that the metal films 61 to 64 may be made of a stacked body of a number of metal films. The metal films constituting the metal films 61 to 64 may include several types of metal films that differ in melting point. The metal films 61 to 64 may include a first metal film, and a second metal film provided on the first metal film, which has a lower melting point than the first metal film. In that case, the second metal film may cover the insulating layers 51, 52.

The metal films 61 to 64 may preferably have a thickness, for example, on the order of about 20 μm to about 40 μm.

As shown in FIG. 1, a protective layer 70 is provided which surrounds each of the region provided with the low-melting-point metal portion 41 and the region provided with the low-melting-point metal portion 42. This provided protective layer effectively prevents a melt of the low-melting metal from spreading wetly in an unintended direction. The protective layer 70 may preferably have a thickness, for example, on the order of about 10 μm to about 20 μm.

Next, the fuse function achieved by the fuse 1 will be described.

For example, when an overcurrent flows between the first terminal 11 and the second terminal 12, the fuse electrode portions 13a, 13b generate heat which are small in width. This heat generation heats and melts the low-melting-point metal portions 41, 42. Furthermore, the insulating layers 51, 52 are also melted, and a melt of the low-melting-point metal is brought into contact with the fuse electrode portions 13a, 13b. As a result, the fuse electrode portions 13a, 13b are dissolved in the melt of the low-melting-point metal to fuse the wiring 13. Thus, the fuse function is achieved.

The fuse 1 includes the insulating layers 51, 52 provided between the wiring 13 and the low-melting-point metal portions 41, 42. The insulating layers 51, 52 electrically insulate the wiring 13 from the low-melting-point metal portions 41, 42. For this reason, the wiring 13 has high resistivity unlike when the low-melting-point metal portions are electrically connected to the wiring. Therefore, the wiring 13 is more likely to generate heat, when an overcurrent flows between the first terminal 11 and the second terminal 12. Accordingly, the fuse 1 achieves the fuse function with a high degree of certainty, when an overcurrent flows between the first terminal 11 and the second terminal 12.

In addition, in the fuse 1, the melting point of the insulating layers 51, 52 is higher than the melting point of the low-melting-point metal portions 41, 42. For this reason, the resistivity of the wiring 13 is effectively prevented from decreasing, with the low-melting-point metal portions 41, 42 in contact with the wiring 13 until the insulating layers 51, 52 are melted. Accordingly, the fuse function is achieved with a higher degree of certainty.

From the perspective of achieving the fuse function with a much higher degree of certainty, the melting point of the insulating layers 51, 52 is preferably at least about 10° C. higher, and further preferably at least about 20° C. higher than the melting point of the low-melting-point metal portions 41, 42. However, when the melting point of the insulating layers 51, 52 is excessively higher than the melting point of the low-melting-point metal portions 41, 42, the insulating layers 51, 52 are less likely to be melted, the melt of the low-melting-point metal is made less likely to be brought into contact with the wiring 13, and the fuse function may be made less likely to be achieved. Accordingly, the melting point of the insulating layers 51, 52 is preferably equal to or lower than the melting point of the low-melting-point metal portions 41, 42 of about +50° C., and more preferably equal to or lower than the melting point of the low-melting-point metal portions 41, 42 of about +30° C., for example. Specifically, the melting point of the insulating layers 51, 52 preferably falls within the range of about 180° C. to about 350° C., more preferably within the range of about 220° C. to about 320° C., and further preferably within the range of about 260° C. to about 280° C., for example.

Now, in order to ensure that the wiring 13 is fused by the melt of the low-melting-point metal, it is important to ensure that the melt of the low-melting-point metal is kept in the region which can come into contact with the wiring 13. However, the insulating layers 51, 52 which have low wettability to the melt of the low-melting-point metal are provided below the low-melting-point metal portions 41, 42, and the melt of the low-melting-point metal is thus more likely to be displaced. Therefore, the fuse 1 includes, on the insulating substrate 20, the metal films 61 to 64 placed outside the insulating layers 51, 52. Due to the melt of the low-melting-point metal in contact with the metal films 61 to 64, the melt of the low-melting-point metal is trapped by the metal films 61 to 64. Accordingly, the fuse 1 ensures that the melt of the low-melting-point metal is kept in the region which can come into contact with the wiring 13. Accordingly, the fuse 1 achieves the fuse function with a high degree of certainty.

From the perspective of ensuring that the melt of the low-melting-point metal is trapped by the metal films 61 to 64, the low-melting-point metal portions 41, 42 are preferably provided to be brought into contact with the metal films 61 to 64. The metal films 61 to 64 are preferably provided on both sides of the insulating layers 51, 52 in the width direction of the wiring 13. The metal films 61 to 64 are preferably provided on both sides of the fuse electrode portions 13a, 13b in the width direction of the wiring 13. The low-melting-point metal portions 41, 42 are preferably provided to cover from the metal film 61 to the metal film 62, and from the metal film 63 to the metal film 64, which are provided on both sides of the wiring 13.

Furthermore, the fuse 1 causes the heating element 15 to generate heat, thus achieving the fuse function, even when no overcurrent flows between the first terminal 11 and the second terminal 12. Specifically, power is supplied between the third terminal 14 and the terminal 11, 12 or terminal 16 to cause the heating element 15 to generate heat. This heat from the heating element 15 melts the low-melting-point metal portions 41, 42 to fuse the fuse electrode portions 13a, 13b of the wiring 13.

In the case of the fuse 1, the heating element 15 and the wiring 13 are connected by the high heat conductor 38 which is provided in the through hole 36a and higher in thermal conductivity than the insulating layer 36. For this reason, the heat from the heating element 15 is more likely to be transferred to the low-melting-point metal portions 41, 42 through the wiring 13. Accordingly, the fuse 1 achieves the fuse function with a high degree of certainty, even in the case of causing the heating element 15 to generate heat to actively achieve the fuse function.

From the perspective of achieving the fuse function with a higher degree of certainty, the through hole 36a is preferably provided so as not to have any overlap with the low-melting-point metal portions 41, 42 in planar view. In the case of the low-melting-point metal portions 41, 42 located over the through hole 36a, there is a need to fuse even the high heat conductor 38 along with the wiring 13 when the high heat conductor 38 has conductivity, in order to fuse the wiring 13 to insulate the first terminal 11 and the second terminal 12 from each other. On the other hand, in the case of the through hole 36a provided so as not to have any overlap with the low-melting-point metal portions 41, 42 in planar view, the first terminal 11 and the second terminal 12 are insulated from each other just by fusing only the wiring 13. Accordingly, the fuse function is made more likely to be achieved.

A modification example of a preferred embodiment described above will be described below. In the following description, members that have functions substantially in common with a preferred embodiment described above will be denoted by common reference symbols, and descriptions of the members will be left out.

### FIRST MODIFICATION EXAMPLE

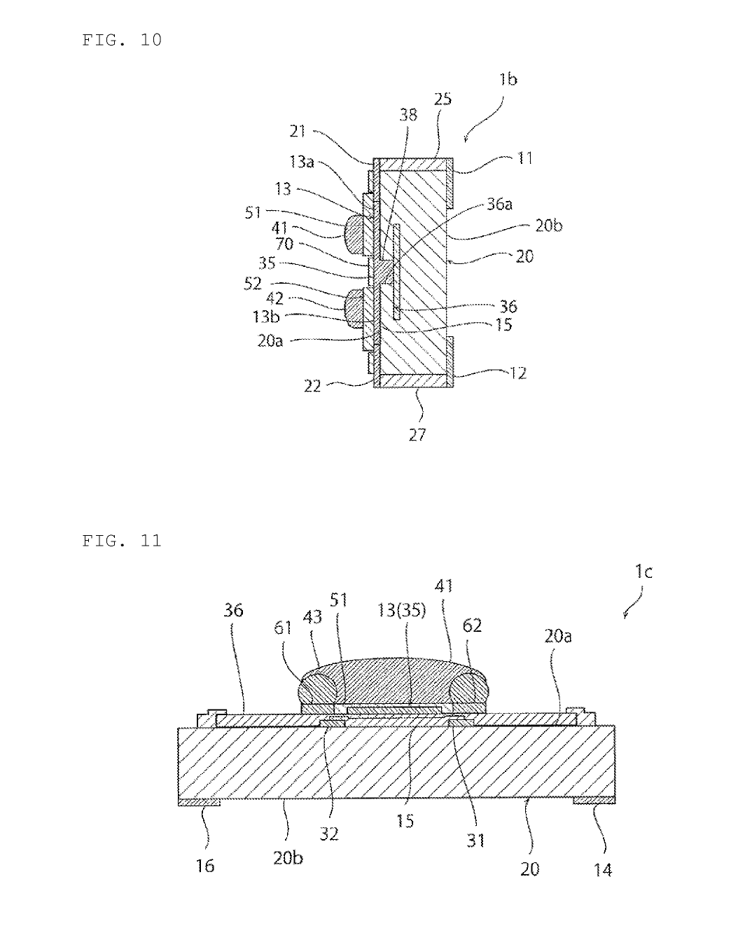

FIG. 9 is a schematic cross-sectional view of a fuse according to a first modification example of a preferred embodiment of the present invention.

As shown in FIG. 9, a fuse la may further include an insulating layer 80 that covers low-melting-point metal portions 41, 42, and has a melting point higher than the melting point of the low-melting-point metal portions 41, 42. This insulating layer 80 prevents a melt of the low-melting metal, produced by melting the low-melting-point metal portions 41, 42, from spreading wetly in an unintended direction.

The melting point of the insulating layer 80 is preferably at least about 10° C. higher, more preferably at least about 20° C. higher than the melting point of the low-melting-point metal portions 41, 42. The insulating layer 80 may preferably include an insulating material that to configure the insulating layers 51, 52, such as polyethylene terephthalate, polybutylene terephthalate, and polycarbonate, for example.

### SECOND MODIFICATION EXAMPLE

FIG. 10 is a schematic cross-sectional view of a fuse according to a second modification example of a preferred embodiment of the present invention.

In regard to the fuse 1 according to a preferred embodiment described above, an example of the heating element 15 provided on the insulating substrate 20 has been described. However, the present invention is not limited to this configuration. As shown in FIG. 10, a fuse 1b according to the present modification example includes a heating element 15 provided within the insulating substrate 20. A portion of the insulating substrate 20, located between the heating element 15 and a wiring 13, constitutes an insulating layer 36. Even in such a case, substantially the same effect is obtained as in a preferred embodiment described above.

### THIRD MODIFICATION EXAMPLE

FIG. 11 is a schematic cross-sectional view of a fuse according to a third modification example of a preferred embodiment of the present invention. As shown in FIG. 11, a fuse 1c includes a high-melting-point metal portion 43 provided between low-melting-point metal portions 41, 42 and metal films 61 to 64, and the low-melting-point metal portions 41, 42 may be connected to the metal films 61 to 64 with the high-melting-point metal portion 43 interposed therebetween. The melting point of the high-melting-point metal portion 43 is higher than the melting point of the low-melting-point metal portions 41, 42, and lower than the melting point of the metal films 61 to 64. Specifically, Sn90Pb, for example, may preferably be used as the high-melting-point metal.

For example, with the low-melting-point metal portions 41, 42 in direct contact with the metal films 61 to 64, when the metal films 61 to 64 are small in thickness, there is a possibility that on melting the low-melting-point metal portions 41, 42, the metal films 61 to 64 will be fused by the melt of the low-melting-point metal to cause the melt of the low-melting-point metal to spread wetly in an unintended direction. In contrast, when the high-melting-point metal portion 43 is provided as in the present modification example, the high-melting-point metal portion 43 prevents the metal films 61 to 64 from being fused by a melt of the low-melting-point metal. Accordingly, a melt of the low-melting-point metal is prevented more reliably from spreading wetly in an unintended direction. Furthermore, the low-melting-point metal portions 41, 42 covering from the metal films 61, 63 to the metal films 52, 64 is formed stably by providing the high-melting-point metal portion 43.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A fuse comprising:
an insulating substrate;
a wiring located on one principal surface of the insulating substrate;
a low-melting-point metal portion provided over the wiring, the metal portion having a lower melting point than the wiring, and dissolving the wiring when the metal portion turns into a melt;
an insulating layer located between the wiring and the low-melting-point metal portion; and
metal films located outside the insulating layer on the insulating substrate.

3. The fuse according to claim 2, wherein the low-melting-point metal portion is provided in contact with the metal films.

4. The fuse according to claim 2, wherein the metal films are provided on both sides of the insulating layer in a width direction of the wiring.

5. The fuse according to claim 4, wherein the low-melting-point metal portion covers an area extending from one of the two metal films to the other.

6. The fuse according to claim 3, wherein the fuse connects the low-melting-point metal portion to the metal films, and the fuse further comprises a high-melting-point metal portion that is higher in melting point than the low-melting-point metal portion, and lower in melting point than the metal films.

7. The fuse according to claim 2, wherein the insulating layer is higher in melting point than the low-melting-point metal portion.

8. The fuse according to claim 2, wherein the insulating layer comprises a thermoplastic resin.

9. The fuse according to claim 2, further comprising a heating element that heats the low-melting-point metal portion.

10. The fuse according to claim 2, wherein the low-melting-point metal portion includes Sn as a main constituent.

11. The fuse according to claim 2, wherein the wiring is connected between a first terminal and a second terminal.

12. The fuse according to claim 2, wherein the wiring includes fuse electrode portions connected in series.

13. The fuse according to claim 2, wherein the fuse is configured to function as an active element that detects an overcurrent.

14. The fuse according to claim 2, wherein the fuse is configured to function as a passive element that detects an overcurrent.

15. The fuse according to claim 2, wherein the fuse is configured to function as an active element and as a passive element that detects an overcurrent.

16. The fuse according to claim 2, wherein the insulating layer is arranged over an entire overlapping area between the wiring and the metal portion.

17. The fuse according to claim 2, wherein the insulating layer includes an opening in which the wiring and the metal portion are connected.

18. The fuse according to claim 2, further comprising another insulating layer that covers the low-melting-point metal portion.

19. The fuse according to claim 9, wherein the heating element is located on a surface of the insulating substrate.

20. The fuse according to claim 9, wherein the heating element is located inside of the insulating substrate.

21. The fuse according to claim 6, wherein the high-melting-point metal portion is located between the low-melting-point metal portion and the metal films.
